(19) United States
(12) Patent Application Publication
(10) Pub. No.: US 2014/0040848 A1
(43) Pub. Date: Feb. 6, 2014

(54) Controllable Turn-Around Time For Post Tape-Out Flow

(71) Applicant: Mentor Graphics Corporation, Wilsonville, OR (US)

(72) Inventors: Toshikazu Endo, San Jose, CA (US); Minyoung Park, Los Altos, CA (US); Pradiptya Ghosh, San Jose, CA (US); Steffen F. Schulze, Sherwood, OR (US)

(73) Assignee: Mentor Graphics Corporation, Wilsonville, OR (US)

(21) Appl. No.: 13/767,870

(22) Filed: Feb. 14, 2013

Related U.S. Application Data
(60) Provisional application No. 61/598,823, filed on Feb. 14, 2012.

(51) Int. Cl. G06F 17/50

(52) U.S. Cl. CPC G06F 17/5072
USPC 716/123

(57) ABSTRACT

A typical post-out flow data path at the IC Fabrication has following major components of software based processing—Boolean operations before the application of resolution enhancement techniques (RET) and optical proximity correctin (OPC), the RET and OPC step [etch retargeting, sub-resolution assist feature insertion (SRAF) and OPC], post-OPCRET Boolean operations and sometimes in the same flow simulation based verification. There are two objectives that an IC Fabrication tapeout flow manager wants to achieve with the flow—predictable completion time and fastest turn-around time (TAT). At times they may be competing. An alternative method of providing target turnaround time and managing the priority of jobs while not doing any upfront resource modeling and resource planning is disclosed. The methodology systematically either meets the turnaround time need and potentially lets the user know if it will not as soon as possible.

### RELATED APPLICATIONS

This application claims priority under 35 U.S.C. §119 to U.S. Provisional Patent Application No. 61/598,823, filed on Feb. 14, 2012, entitled “Predictable Turn-Around Time For Post Tape-Out Flow,” and naming Toshikazu Endo et al. as inventors, which application is incorporated entirely herein by reference. This application is related to U.S. Provisional Patent Application No. 61/418,213, filed on Nov. 30, 2010, entitled “Dynamic Runtime Prediction For Hierarchical Tile-Based Processing,” and naming Toshikazu Endo et al. as inventors, which application is incorporated entirely herein by reference. This application also is related to U.S. patent application Ser. No. 13/308,525, filed on Nov. 30, 2011, entitled “Dynamic Runtime Length Prediction For Electronic Design Automation Operations,” and naming Toshikazu Endo et al. as inventors, which application also is incorporated entirely herein by reference.

### FIELD OF THE INVENTION

The present invention is directed the techniques for controlling the turnaround time of an electronic design automation process. Various implementations of the invention may be applicable to controlling the turnaround time of an electronic design automation process operating on layout design data.

### BACKGROUND OF THE INVENTION

Microdevices, such as integrated microcircuits and microelectromechanical systems (MEMS), are used in a variety of products, from automobiles to microwaves to personal computers. Designing and fabricating microdevices typically involves many steps, known as a “design flow.” The particular steps of a design flow often are dependent upon the type of microcircuit, its complexity, the design team, and the microdevice fabricator or foundry that will manufacture the microcircuit. Typically, software and hardware “tools” verify the design at various stages of the design flow by running software simulators and/or hardware emulators, and errors in the design are corrected or the design is otherwise improved.

Several steps are common to most design flows for integrated microcircuits. Initially, the specification for a new circuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logic of the circuit is then analyzed, to confirm that it will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This device design generally corresponds to the level of representation displayed in conventional circuit diagrams. Preliminary timing estimates for portions of the circuit may be made at this stage, using an assumed characteristic speed for each device. In addition, the relationships between the electronic devices are analyzed, to confirm that the circuit described by the device design will correctly perform the desired functions. This analysis is sometimes referred to as “formal verification.”

Once the relationships between circuit devices have been established, the design is again transformed, this time into a physical design that describes specific geometric elements. This type of design often is referred to as a “layout” design. The geometric elements, which typically are polygons, define the shapes that will be created in various materials to manufacture the circuit. Typically, a designer will select groups of geometric elements representing circuit device components (e.g., contacts, gates, etc.) and place them in a design area. These groups of geometric elements may be custom designed, selected from a library of previously-created designs, or some combination of both. Lines are then routed between the geometric elements, which will form the wiring used to interconnect the electronic devices. Layout tools (often referred to as “place and route” tools), such as Mentor Graphics' IC Station or Cadence's Virtuoso, are commonly used for both of these tasks.

With a layout design, each physical layer of the circuit will have a corresponding layer representation in the design, and the geometric elements described in a layer representation will define the relative locations of the circuit device components that will make up a circuit device. Thus, the geometric elements in the representation of an implant layer will define the doped regions, while the geometric elements in the representation of a metal layer will define the locations in a metal layer where conductive wires will be formed to connect the circuit devices. In addition to integrated circuit microdevices, layout design data also is used to manufacture other types of microdevices, such as microelectromechanical systems (MEMS). Typically, a designer will perform a number of analyses on the layout design data. For example, with integrated circuits, the layout design may be analyzed to confirm that it accurately represents the circuit devices and their relationships as described in the device design. The layout design also may be analyzed to confirm that it complies with various design requirements, such as minimum spacings between geometric elements. Still further, the layout design may be modified to include the use of redundant geometric elements or the addition of corrective features to various geometric elements, to counteract limitations in the manufacturing process, etc.

In particular, the design flow process may include one or more resolution enhancement technique (RET) processes. These processes will modify the layout design data, to improve the usable resolution of the reticle or mask created from the design in a photolithographic manufacturing process. One such family of resolution enhancement technique (RET) processes, sometimes referred to as optical proximity correction (OPC) processes, may add features such as serifs or indentations to existing layout design data in order to compensate for diffractive effects during a lithographic manufacturing process. For example, an optical proximity correction process may modify a polygon in a layout design to include a “hammerhead” shape, in order to decrease rounding of the photolithographic image at the corners of the polygon.

After the layout design has been finalized, it is converted into a format that can be employed by a mask or reticle writing tool to create a mask or reticle for use in a photolithographic manufacturing process. The written masks or reticles then can be used in a photolithographic process to expose selected areas of a wafer to light or other radiation in order to produce the desired integrated microdevice structures on the wafer.

With growing complexity in data preparation and flows that are composed of multiple steps—including electronic design automation processes like RET, OPC, MRC, MDP and others it is not uncommon that the overall computation time is exceeding 24 hours for each mask. Migration to new technology nodes and shrinking feature size is escalating the issue. The data preparation time is part of the critical path to deliver masks and subsequently the first functional devices. Hence optimization of the data preparation flow is an important element of optimization of the overall manufacturing process.

One important aspect of the data preparation flow process is the ability to predict and plan for the resource required, and to predict the completion time for the execution of a particular flow implementation. Some of the electronic design automation algorithms used in the data preparation flow processes are inherently not scalable, and when acceleration algorithms are used they become even more unpredictable. The choice at hand is either to avoid the use of highly effective acceleration algorithms, or to contain and compensate the unpredictability of these flow elements. Giving up on the potential of these methods may be a high price—an increased computational effort with the subsequently higher software and hardware cost, or delays in the delivery of the mask.

### BRIEF DESCRIPTION OF THE DRAWINGS

FIGS. 1 and 2 illustrate components and operation of a computer network having a host or master computer and one or more remote or servant computers that may be employed to implement various embodiments of the invention.

FIGS. 3 and 4 show processing time variation of a series of test cases representing different design styles including memory and logic designs from various sources.

FIGS. 5 and 6 illustrate different design hierarchies.

FIG. 7 illustrates limitations on the scalability of cell base processing by number of cells and cell dependency in the design hierarchy.

FIG. 8 how hierarchical tile processing has better scalability than cell based processing because of finer computational granularity.

FIG. 9 illustrates how simulation dominated operations are the main resource consumption operations for various implementations of the invention.

FIG. 10 shows prediction errors by ECP among different operations and different design styles for various implementations of the invention.

FIG. 11 illustrates how the resource manager application allocates those resources to each job for various implementations of the invention.

FIG. 12 shows an example of controlling operation length to 200 minutes for various implementations of the invention.

FIG. 13 illustrates how various implementations of the invention may use a special budget “EXTRA” for non-scalable operations.

FIG. 14 shows an example of increasing job priority due to resource competition.

FIG. 15 shows another example of controlling TAT of multiple jobs in the same grid according to various implementations of the invention.

FIG. 16 shows an example of scheduling priorities of multiple jobs according to various implementations of the invention.

FIG. 17 shows the whole resource allocation plots of job 1 and job 2 illustrated in FIG. 16.

### DETAILED DESCRIPTION OF THE INVENTION

### Exemplary Operating Environment

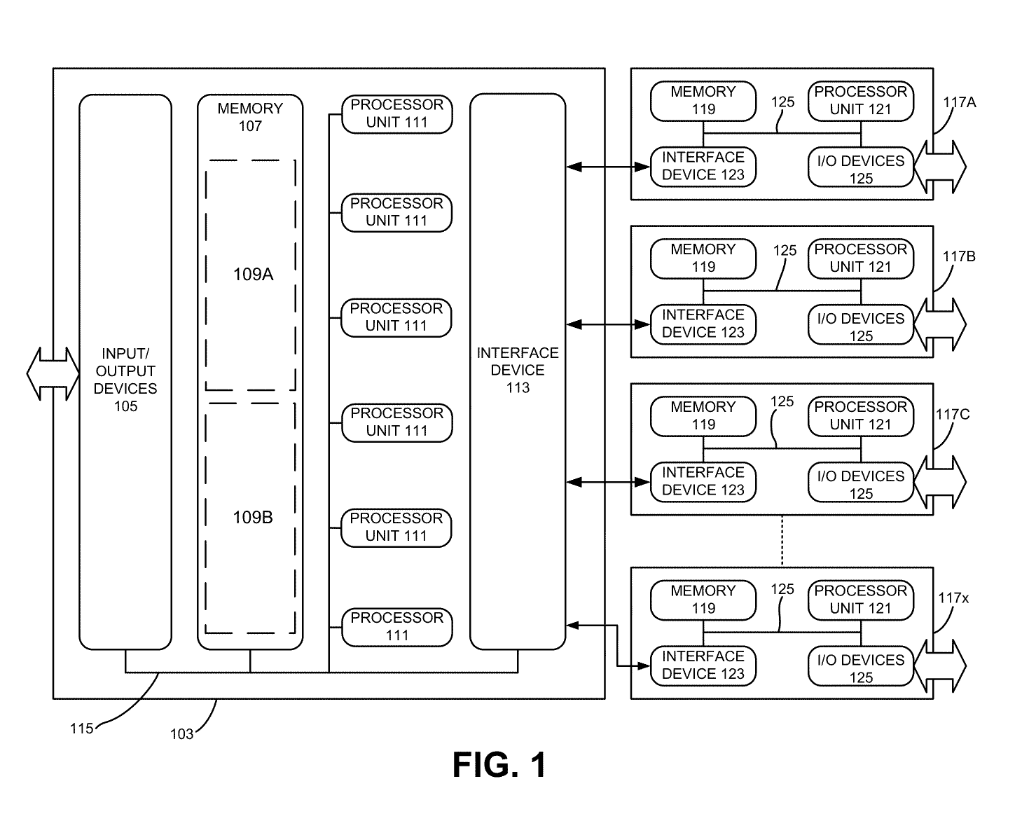

The execution of various electronic design automation processes according to embodiments of the invention may be implemented using computer-executable software instructions executed by one or more programmable computing devices. Because these embodiments of the invention may be implemented using software instructions, the components and operation of a generic programmable computer system on which various embodiments of the invention may be employed will first be described. Further, because of the complexity of some electronic design automation processes and the large size of many circuit designs, various electronic design automation tools are configured to operate on a computing system capable of simultaneously running multiple processing threads. The components and operation of a computer network having a host or master computer and one or more remote or servant computers therefore will be described with reference to FIG. 1. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

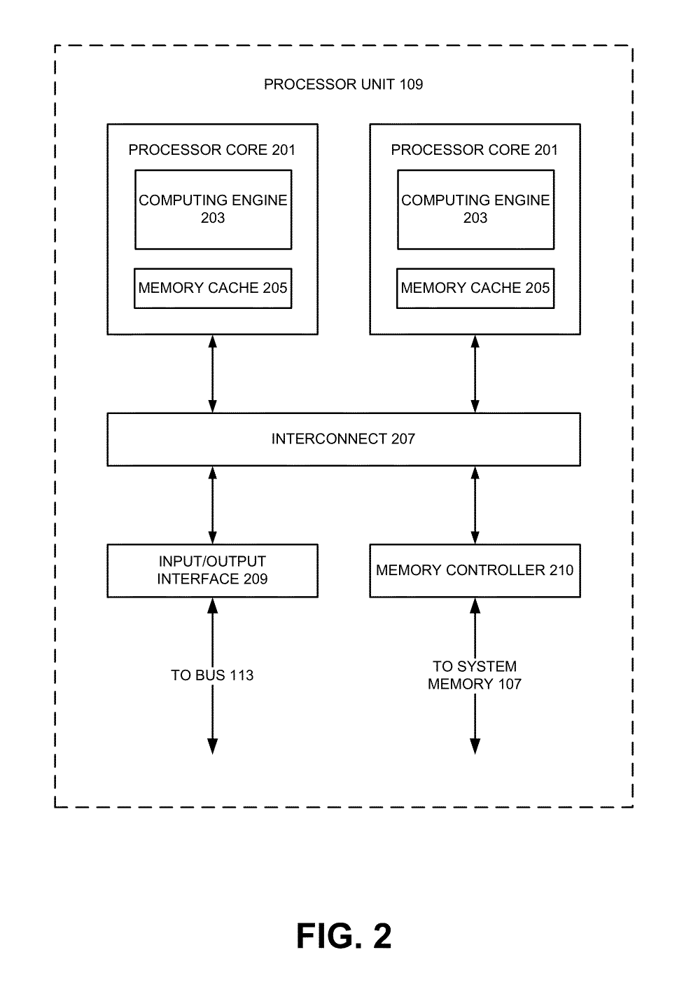

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interface 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201.

While FIG. 2 shows one illustration of a processor unit 201 that may be employed by some embodiments of the invention, it should be appreciated that this illustration is representative only, and is not intended to be limiting. For example, some embodiments of the invention may employ a master computer 103 with one or more Cell processors. The Cell processor employs multiple input/output interfaces 209 and multiple memory controllers 211. Also, the Cell processor has nine different processor cores 201 of different types. More particularly, it has six or more synergistic processor elements (SPEs) and a power processor element (PPE). Each synergistic processor element has a vector-type computing engine 203 with 428×428 bit registers, four single-precision floating point computational units, four integer computational units, and a 556 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the servant computers 117A, 117B, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the servant computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each servant computer 117 may include a memory 119, a processor unit 121, an interface device 123, and, optionally, one more input/output devices 125 connected together by a system bus 127. As with the master computer 103, the optional input/output devices 125 for the servant computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of the computer readable media discussed above. Like the interface device 113, the interface devices 123 allow the servant computers 117 to communicate with the master computer 103 over the communication interface.

In the illustrated example, the master computer 103 is a multi-processor unit computer with multiple processor units 111, while each servant computer 117 has a single processor unit 121. It should be noted, however, that alternate implementations of the invention may employ a master computer having single processor unit 111. Further, one or more of the servant computers 117 may have multiple processor units 121, depending upon their intended use, as previously discussed. Also, while only a single interface device 113 or 123 is illustrated for both the master computer 103 and the servant computers, it should be noted that, with alternate embodiments of the invention, either the computer 103, one or more of the servant computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the servant computers 117 may alternately or additionally be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only, and it not intended to suggest any limitation as to the scope of use or functionality of alternate embodiments of the invention.

### Hierarchical Organization of Data

The design of a new integrated circuit may include the interconnection of millions of transistors, resistors, capacitors, or other electrical structures into logic circuits, memory circuits, programmable field arrays, and other circuit devices. In order to allow a computer to more easily create and analyze these large data structures (and to allow human users to better understand these data structures), they are often hierarchically organized into smaller data structures, typically referred to as “cells.” Thus, for a microprocessor or flash memory design, all of the transistors making up a memory circuit for storing a single bit may be categorized into a single “bit memory” cell. Rather than having to enumerate each transistor individually, the group of transistors making up a single-bit memory circuit can thus collectively be referred to and manipulated as a single unit. Similarly, the design data describing a larger 16-bit memory register circuit can be categorized into a single cell. This higher level “register cell” might then include sixteen bit memory cells, together with the design data describing other miscellaneous circuitry, such as an input/output circuit for transferring data into and out of each of the bit memory cells. Similarly, the design data describing a 128 kB memory array can then be concisely described as a combination of only 64,000 register cells, together with the design data describing its own miscellaneous circuitry, such as an input/output circuit for transferring data into and out of each of the register cells. Of course, while the above-described example is of design data organized hierarchically based upon circuit structures, circuit design data may alternately or additionally be organized hierarchically according to any desired criteria including, for example, a geographic grid of regular or arbitrary dimensions (e.g., windows), a memory amount available for performing operations on the design data, design element density, etc.

By categorizing microcircuit design data into hierarchical cells, large data structures can be processed more quickly and efficiently. For example, a circuit designer typically will analyze a design to ensure that each circuit feature described in the design complies with design rules specified by the foundry that will manufacture microcircuits from the design. With the above example, instead of having to analyze each feature in the entire 128 kB memory array, a design rule check process can analyze the features in a single bit cell. The results of the check will then be applicable to all of the single bit cells. Once it has confirmed that one instance of the single bit cells complies with the design rules, the design rule check process then can complete the analysis of a register cell simply by analyzing the features of its additional miscellaneous circuitry (which may itself be made of up one or more hierarchical cells). The results of this check will then be applicable to all of the register cells. Once it has confirmed that one instance of the register cells complies with the design rules, the design rule check software application can complete the analysis of the entire 128 kB memory array simply by analyzing the features of the additional miscellaneous circuitry in the memory array. Thus, the analysis of a large data structure can be compressed into the analyses of a relatively small number of cells making up the data structure.

### Design Classification

As used herein, the term “design” is intended to encompass data describing an entire microdevice, such as an integrated circuit device or micro-electromechanical system (MEMS) device. This term also is intended to encompass a smaller group of data describing one or more components of an entire microdevice, however, such as a layer of an integrated circuit device, or even a portion of a layer of an integrated circuit device. Still further, the term “design” also is intended to encompass data describing more than one microdevice, such as data to be used to create a mask or reticle for simultaneously forming multiple microdevices on a single wafer. The layout design data may be in any desired format, such as, for example, the Graphic Data System II (GDSII) data format or the Open Artwork System Interchange Standard (OASIS) data format proposed by Semiconductor Equipment and Materials International (SEMI). Other formats include an open source format named Open Access, Milkyway by Synopsys, Inc., and EDDM by Mentor Graphics, Inc.

In the post-out flow, the data processing time varies depending on the design style and the operation type. Design style consists of several properties, for instance—hierarchical efficiency, geometry count, cell size, skewed edge count, cell overlaps and etc. Depending on the operation type, design properties that affect the processing time is different. The hierarchical efficiency is defined as the ratio of the flat geometry count and the hierarchical geometry count.

$$Hierarchical efficiency = \frac{Flat geometry count}{Hiererchcical geometry count}$$

Typically, logic design and memory design have very different design attributes, so especially hierarchical efficiencies vary widely.

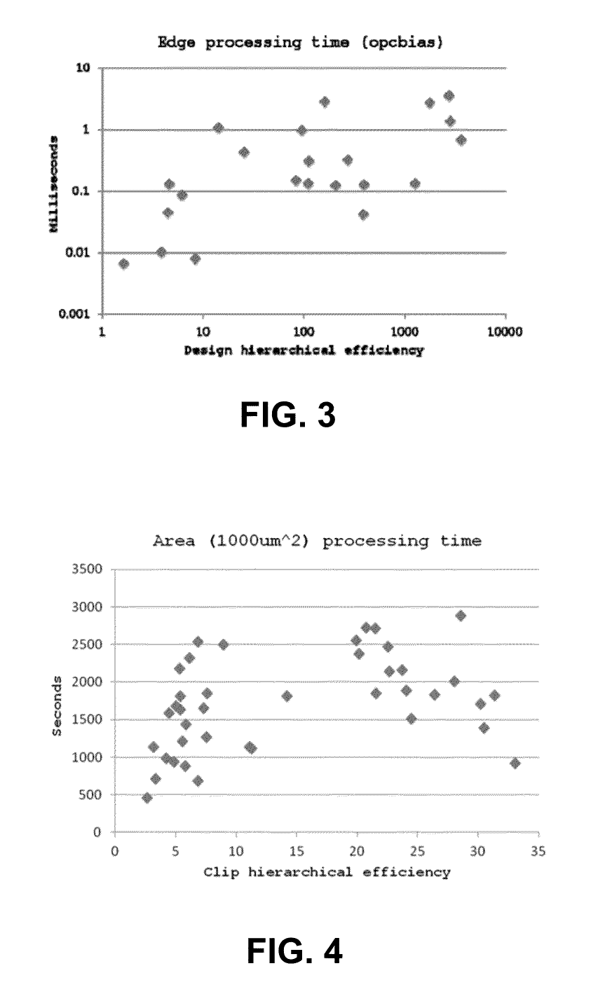

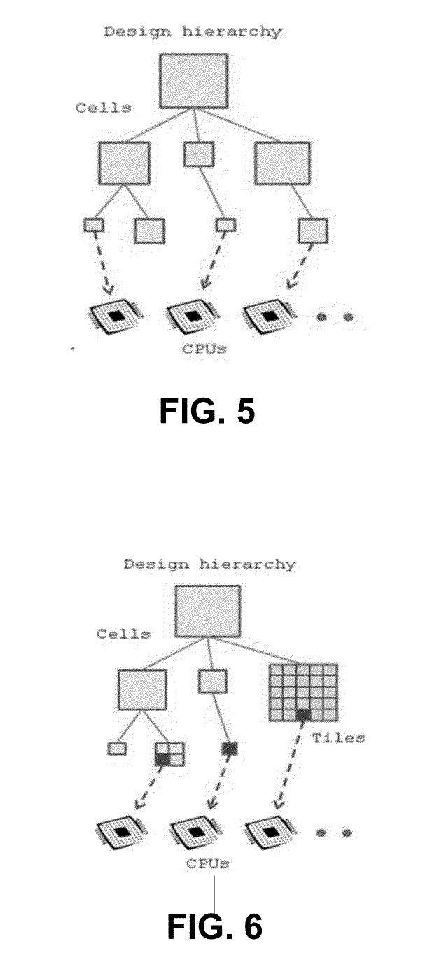

FIG. 3 shows processing time variation of a series of test cases representing different design styles including memory and logic designs from various sources. The process node is 45 nm. Each data point lists edge processing time of different test cases for a rule based OPC operation used in optical proximity correction (OPC). The x-axis shows the hierarchical efficiency of each design. The operation conducts geometrical computation: moving edges depending on geometry shape or space, therefore it is anticipated that geometry counts in the target cells are a dominant factor of the processing time.

A significant variation of the processing time is observed. Apparently, the processing time per geometry varies by the input design styles. FIG. 3 shows an example for simulation base data processing. Each data point represents the processing time of a 1000 μm2 clip from a different location in the full chip layout (45 nm node) that contains both logic and memory blocks. The x-axis shows the hierarchical efficiency of each clip. The simulation process itself consumes constant processing time for the same area size. However, the process additionally involves geometric processing such rasterization; therefore the processing time is variable and not solely a function of area size. Because of the processing time dependency on design style and content, a static runtime estimation of an unknown layout is difficult for pre-dominantly non-simulation based operations.

### Algorithm Classification

There are two aspects of data processing in the post-out flow: the processed data unit and the data processing algorithm. The processed data unit is determined by the computational granularity and the data type, i.e., hierarchical or flat. There are three basic processed data units. With the hierarchical cell, data is processed per cell in the design hierarchy. With the hierarchical tile, data is processed per tiles that are generated by dividing the hierarchical design cell. With the flat tile, data is processed per tile that are generated by dividing flatten design.

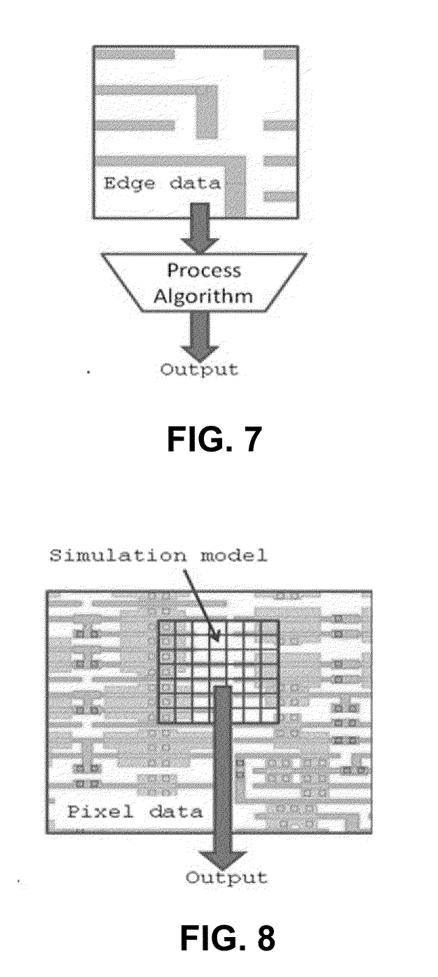

Hierarchical cell processing is a straightforward implementation that traverses cell data from bottom to top cell in the design hierarchy. The scalability of cell base processing is limited by number of cells and cell dependency in the design hierarchy, as shown in FIG. 7. Hierarchical tile processing is better scalability than cell base processing because of finer computational granularity, as shown in FIG. 8.

Tile size variation is much smaller than cell size variation, therefore tile processing time variation is also smaller. The small processing time variation and the finer computational granularity allow better dynamic runtime estimation—it is possible to compute estimated completion percent (ECP) during “big” cell processing, and it has linear trend to the actual resource usage in many cases. The ECP is computed by dividing amount of prediction parameter in processed tiles by total prediction parameter in all tiles. The prediction parameter is selected statically or dynamically depending on the operation type and the operation mode.

The flat tile processing is an alternative way for hierarchical tile processing, in that mode, hierarchical design data is flatten prior to the data processing. It has better performance than hierarchical tile processing if the design data is become very flat.

Geometric based data processing is standard method to process data. It process each geometry vector, the processing time depends on geometry data amount, geometry properties and the process algorithm (code). Simulation based data processing is done by applying simulation model on rasterised data; it is pixel data (not geometric data). Theoretically, the processing time of simulation based data process relies on the target area size. In actuality, however, simulation based data process needs pre or post geometric based data processing, such as rasterization processing, such that the processing time is not purely determined by area size. But it is more predictable than geometric base data processing, if the simulation time dominates the processing time.

In the post-out flow operations, there are two types of operations, non-simulation operation and simulation dominated operation. The non-simulation operations perform basic geometric processing, for example, Boolean operations. The simulation dominated operations are mask data preparation (MDP) dedicated operations such as OPC operations. In general, a post-out flow job contains both simulation dominated and non-simulation operations. Basically, non-simulation operations are hierarchical cell base processing and the processing is geometric computation. The simulation dominated operations are hierarchical tile base processing and the processing is simulation base or geometric or mixed computation.

In general the operations are cascaded, i.e. many operations take data from other operation's output. The actual source data to operation has high impact to the operation TAT. Those intermediate data could be very different from original design data; it causes difficulty of static TAT prediction.

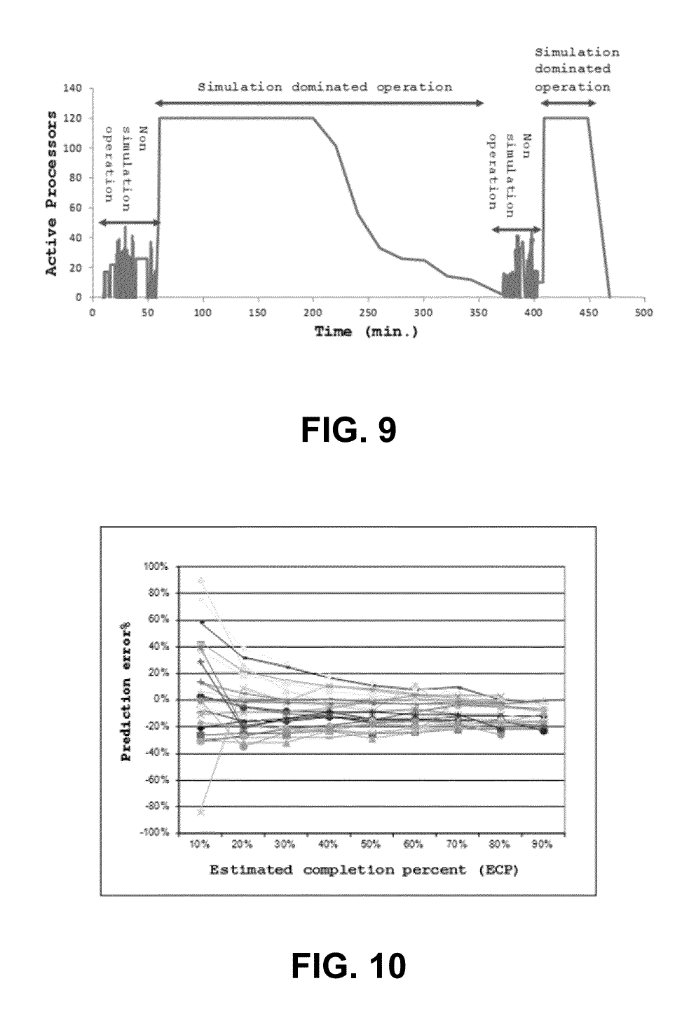

An operation's scalability and predictability are determined by its processing unit and the data processing algorithm. In general, post-out flow job consists of multiple operations; there are different types of operations in a job. Typical job has non-simulation operations and some simulation dominated operations, those simulation dominated operations are become more significant in terms of job TAT. Since simulation dominated operations are the main resource consumption operations, they are critical to consider when predicting and controlling simulation dominated operations, as shown in FIG. 9.

This is typical resource usage pattern; simulation dominated operation(s) is the main resource consumption operation. However, non-simulation operations take a certain amount of real time due to its lack of scalabilities. Accordingly, various implementations of the invention may employ the following assumptions:
There is no static runtime prediction model;
Simulation dominated operation(s) dominate the job TAT (turnaround time);
Runtime prediction (ECP) is available in the simulation dominated operation(s); and
Dynamic resource allocation is available.

Because static TAT prediction may not be available, various implementations of the invention may focus on controlling TAT rather than static runtime estimation, because it is beneficial for the administrators in case of there are priority jobs, and it is necessary to have TAT constraint.

### Turnaround Time (TAT) Control

In various electronic design automation process flow scenarios, simulation dominated operations support dynamic runtime estimation (ECP support), and then simulation dominated operation is dynamically controllable by the finer computational granularity and the ECP. In many cases, the prediction errors of resource usage by ECP are in the certain range. FIG. 10 shows prediction errors by ECP among different operations and different design styles. According to that data, the estimation of remaining resource demand is within 25% error range after 50% of data is processed.

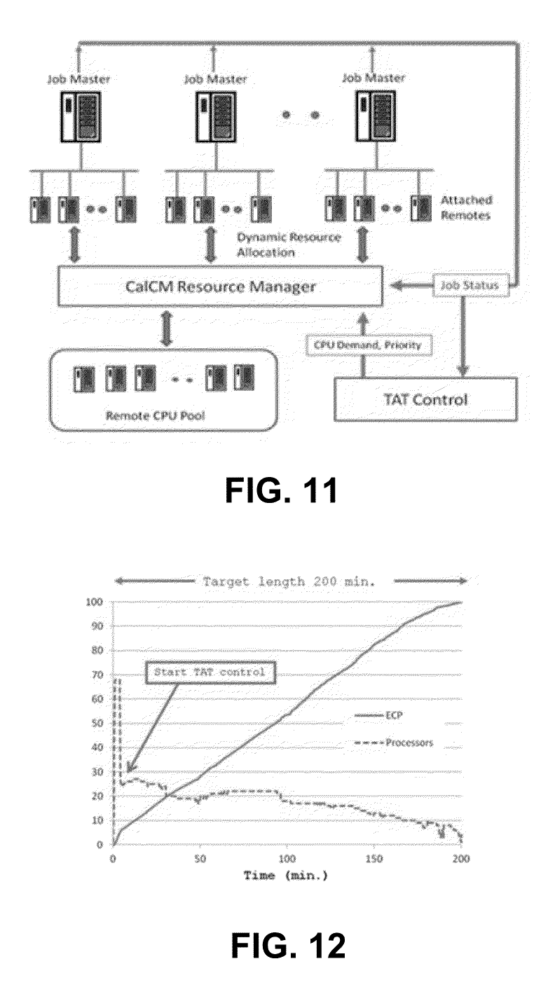

In the dynamic resource allocation environment, various implementations of the invention provide an application that controls job TAT. The TAT control application may work with existing resource allocation applications. With various examples of the invention, the TAT control application does not allocate computational resources directly; rather, it overwrites the job's resource demand and then the resource manager application actually allocates those resources to each job, as shown in FIG. 11.

In order to control job TAT, various implementations of the invention may assign a “budget” to each simulation dominated operation. The budget is a target real time constraint of the operation—processor count is dynamically controlled if an operation has a budget. The budget assigning requires knowledge about reasonable time length for each simulation dominated operation. However budget accuracy is not so critical, because possible duration range of simulation dominated operation is wide if the scalability is large enough. Simple database query of similar job's execution history may allow the budget automation.

In the TAT control application various according to various implementations of the invention, resource consumptions are recorded during operation execution, and then estimated total remaining processing time is computed by projecting used total processing time at each ECP value, which may be calculated as follows:

$$Estimated total remaining processing time = \frac{Cumulative used processing time ( 100 - ECP )}{ECP}$$

To control operation TAT, the computational resources are controlled for the target operation length. The resource demand (number of processors) for the operation is computed at every ECP update by dividing the estimated total remaining processing time by the remaining time, which may be calculated as follows:

$$Number of processors = \frac{Estimated total remaining processing time}{Remaining time}$$

Actually, some additional value may be added to the number of processors because the estimation may have some error, the additional value is changed depending on the ECP value or the correlation index. FIG. 12 shows an example of controlling operation length to 200 minutes. As long as there is a correlation between ECP and computation resource usage, it is possible to control operation TAT by changing processor count based on the estimated remaining processing time.

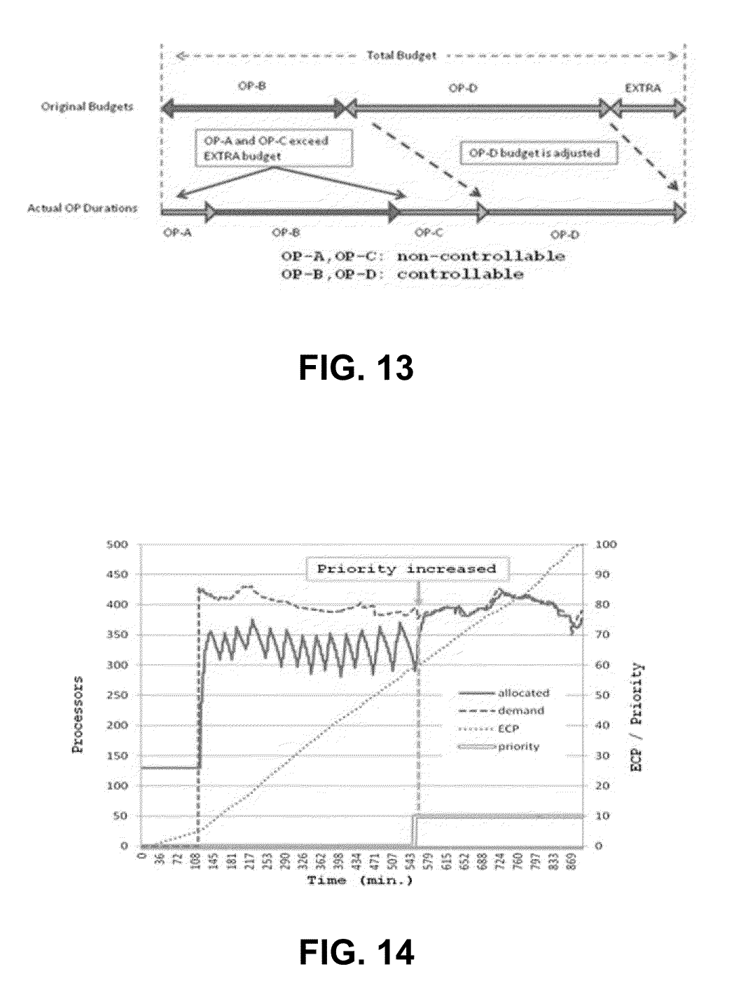

As described as above, a single job contains both scalable and non-scalable operations; therefore TAT control application cannot control those non-scalable operations. Accordingly, various implementations of the invention may use a special budget “EXTRA” for those non-scalable operations. The special budget is a budget for all non-scalable operations, as shown in FIG. 13.

In order to absorb those uncertainties of non-controllable operation's length, various embodiments of the invention will adjust the budget of the controllable operation when the operation is started, as shown in FIG. 1e. This ensures that job TAT will be the target length even though there are non-controllable operations. However there are cases the dynamic budget adjustment does not work:
The cluster size is not large enough for adjusted budget operation
The scalability of adjusted budget operation is not good enough
There is no controllable operation following after non-controllable operations exceed the extra budget.

In the post-out flow, it is rare that only single job runs in the data center; very likely other jobs are running in the same grid. It means resource demands are conflicted if the grid size is smaller than the total resource demands. To address this issue, the resource manager application according to various examples of the invention may support priority scheme that allows the highest priority job gets its requested computational resource regardless of demands from lower priority jobs. For example, some implementations of the invention may provide a priority scheme in order to allocate enough processors to TAT controlled jobs without changing the resource manager behavior. FIG. 14 shows an example of increasing job priority due to resource competition.

As seen in this figure, the allocated count does not follow the resource demand until 60% of ECP; demand of other jobs affects resource allocation of the TAT controlled job. The allocated processor count matched the resource demand after increasing the priority. The TAT control application according to various examples of the invention increases the priority of TAT controlled job, when the job does not get its requested processor count and the estimated completion time exceeds the target.

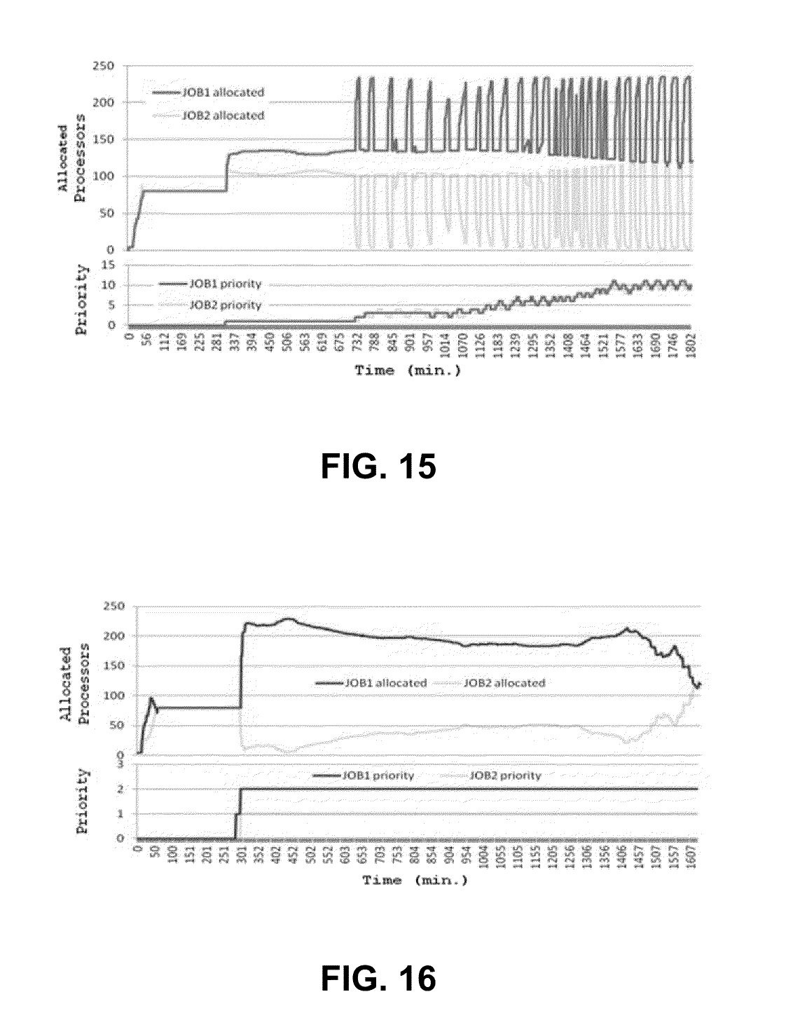

FIG. 15 shows another example of controlling TAT of multiple jobs in the same grid. In this example, resource oscillations due to priority competition are observed between the TAT controlled jobs, job 1 and job 2. Since there is a feedback control loop in the priority control algorithm, the resource oscillating is a natural symptom. However it is better to eliminate those resource oscillations if possible, because those oscillations cause rough TAT control, and there will be overhead of frequent resource re-allocation.

### Job Priority Scheduling

The resource oscillation can be eliminated if the TAT control application is able to schedule execution order of multiple budgeted operations. Basically, with various examples of the invention, the TAT application performs the priority scheduling if the following conditions occur:
There is operation(s) that can wait other operation(s) completion; and
All of the budgeted operations satisfy the budget constraint.

The estimated minimum completion time is calculated for each budgeted operation. If the total estimated minimum completion time is equal or less than the total of remaining time, all budgeted operations can be processed sequentially. The estimated minimum completion time is calculated as follows:

$$Estimated minimum completion time = \frac{Estimated total remaining processing time}{Maximum processor count for single job}$$

FIG. 16 shows an example of scheduling priorities of multiple jobs. In this case, no resource oscillation was observed and all budgeted operations matched the time constraint. The priority of job 1 was kept higher than the priority of job 2, and then job 1 got resources that job 1 requested.

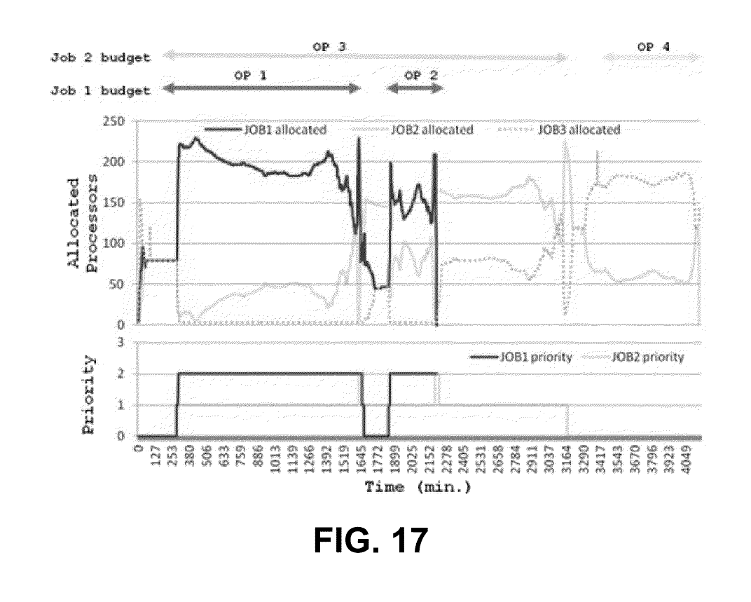

FIG. 17 shows the whole resource allocation plots of job 1 and job 2. In addition to those TAT controlled jobs there is a non-budgeted job 3. The allocated resources of job 3 was ramped up when the resource demands from TAT controlled jobs is smaller than the cluster size (250).

In this example, operation OP 3 is able to wait completions of OP 1 and OP 2, meaning that the following condition was true

OP3 estimated minimum completion time+Budget(OP1+OP2)≦Budget(OP3)

In reality the jobs controlled with TAT will be limited for critical layers. Therefore those TAT jobs could work with other jobs by utilizing voluntarily revoked resources. This is possible because the demand of resources varies for each operation being executed and unused resources can be transferred to other jobs.

### CONCLUSION

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, while specific terminology has been employed above to refer to electronic design automation processes, it should be appreciated that various examples of the invention may be implemented using any desired combination of electronic design automation processes.

What is claimed is:

1. One or more computer readable media storing computer-executable instructions for causing a computer to perform any of the new and nonobvious methods described herein, both alone and in combinations and subcombinations with one another.

2. A method of controlling the turnaround time of one or more electronic design automation processes, comprising any of the new and nonobvious methods described herein, both alone and in combinations and subcombinations with one another.

3. One or more computer readable media storing instructions for controlling the turnaround time of one or more electronic design automation processes in accordance with any of the new and nonobvious methods described herein both alone and in combinations and subcombinations with one another.

6. A system for controlling the turnaround time of one or more electronic design automation processes using any of the new and nonobvious method acts described herein, both alone and in combinations and subcombinations with one another.
